(19) United States
(12) Patent Application Publication
(10) Pub. No.: US 2012/0295242 A1
(43) Pub. Date: Nov. 22, 2012

(54) COMPUTER-BASED ACTIVE TEACHING

(75) Inventors: Sumit Basu, Seattle, WA (US); Janara Christensen, Seattle, WA (US)

(73) Assignee: Microsoft Corporation, Redmond, WA (US)

(21) Appl. No.: 13/107,966

(22) Filed: May 16, 2011

(51) Int. Cl. G09B 7/00

(52) U.S. Cl. 434/350; 434/362

(57) ABSTRACT

The discussion relates to actively teaching a classification boundary. One implementation can obtain examples and a boundary associated with an operational space. This implementation can choose an active teaching strategy to teach the boundary to a user as a classification task. It can select an individual example for presentation to the user utilizing the active teaching strategy. The implementation can receive a user response to the example and evaluate the active teaching strategy in light of the user response.

### BACKGROUND

The present technology relates to utilizing computing devices or computers to teach a human a classification boundary.

### SUMMARY

The discussion relates to actively teaching a classification boundary to a human user. One implementation can obtain examples and a boundary associated with an operational space. This implementation can choose an active teaching strategy to teach the boundary to a user as a classification task. It can select an individual example for presentation to the user utilizing the active teaching strategy. The implementation can receive a user response to the example and evaluate the active teaching strategy in light of the user response.

The above listed example is intended to provide a quick reference to aid the reader and is not intended to define the scope of the concepts described herein.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIG. 1 shows an example of a computer-implemented method of actively teaching a classification boundary in accordance with some implementations of the present concepts.

FIG. 2 shows an example of a system for actively teaching a classification boundary in accordance with some implementations of the present concepts.

FIG. 3 shows some of the elements of system 200 of FIG. 2 in more detail in accordance with some implementations of the present concepts.

FIG. 4 shows a flowchart of an active teaching method in accordance with some implementations of the present concepts.

### DETAILED DESCRIPTION

### Overview

This discussion relates to computer-aided active teaching. More specifically the discussion relates to computer-implemented active teaching of a classification boundary, such as a binary classification boundary, a boundary in a set of multiclass classification boundaries, etc. For instance, a binary classification boundary might separate poisonous mushrooms from safe mushrooms. Briefly, the computer can access a representation of the classification boundary in some high dimensional space (e.g., operational space). The computer can also access and/or generate a large number of examples that are on both sides of the classification boundary. Through presentation of individual examples, the computer can teach a human user or “learner” how to correctly classify items with respect to this classification boundary. Thus, the present implementations can be employed to teach the user a real-world task, such as mushroom identification. These implementations can also be employed to explain a behavior of a classifier or to train the user as a labeler that is consistent with other human labelers, among other uses.

The present implementations can carefully select individual examples to teach the user the classification boundary utilizing a reduced (and potentially minimum) number of examples Some implementations can adapt the teaching behavior based upon the user's responses (e.g., the user's response at each step can be utilized as feedback for the teaching process). Stated another way, the computer can utilize “active teaching” to select examples based on the user's responses such that the user can quickly learn the classification boundary.

### Method Example

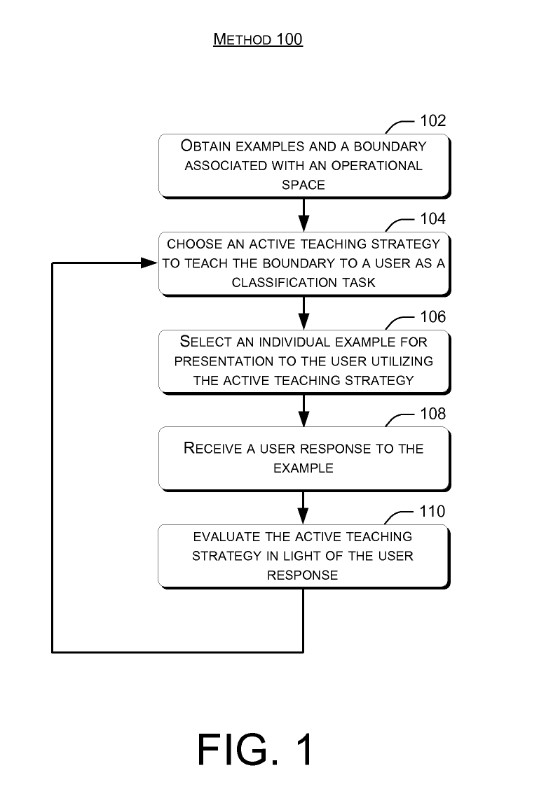

FIG. 1 shows an example computer-implemented method 100 for actively teaching a classification boundary. In one case, the classification boundary can relate to teaching the user a discrimination task, such as telling morel mushrooms from poisonous false morels. In another case the classification boundary can relate to teaching consistent human labelers. In such a case a newly taught human labeler can be trained to have high(er) inter-annotator agreement with past labelers. In still another case the classification boundary can be utilized to explain a classifier, i.e., giving a human confidence about how a classifier will operate by teaching her/him about what decisions the classifier makes. Stated another way, in this last example, a machine learning system may have discovered a boundary for the task; the human user now wants to understand what kinds of decisions the system will make and active teaching can be employed to allow the human user to understand the new boundary and thereby have confidence in the system.

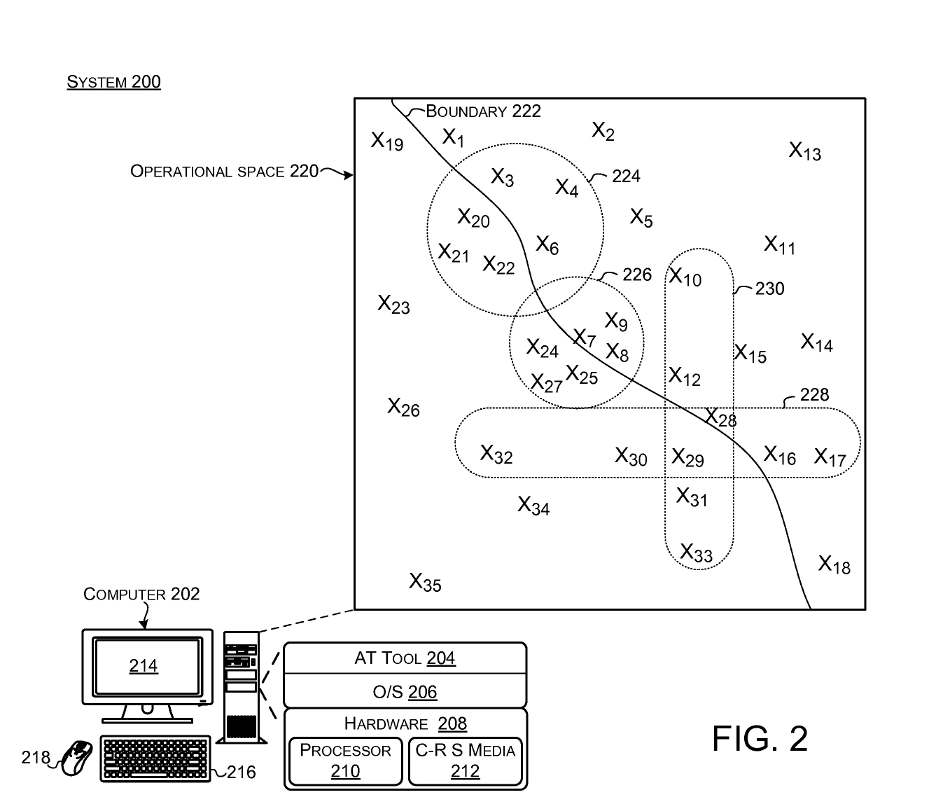

Toward these ends, the method 100 can obtain examples and a boundary associated with an operational space at block 102. A representation of an operational space, boundary, and examples is illustrated and discussed below relative to FIG. 2.

The method can choose an active teaching strategy to teach the boundary to the user as a classification task at block 104. The active teaching strategy can consider one or more parameters or factors that can influence the teaching success. For example, one parameter or factor may relate to the relative hardness of the individual examples presented to the user. This can be used to present the user with examples that are at an appropriate level of difficulty given his/her progress thus far. Another parameter or factor can relate to a tendency of the user to get discouraged by wrong answers (e.g., discouragement parameter). Another parameter may relate to the user's learning style. For instance the user may want to see the “big picture” and not just the boundary. Some implementations can balance multiple parameters or factors in the selection process. For instance, one implementation can operate on the premise that the user can more quickly learn the boundary from harder examples than easier examples. However, the user may become discouraged and quit the exercise if the examples are too difficult. Accordingly, some implementations can balance selection of relatively hard examples with selecting the examples in a manner that does not discourage the user.

The method can select an individual example for presentation to the user utilizing the active teaching strategy at block 106. The active teaching strategy selected at block 104 can determine which of the available examples to present to the user to satisfy or balance the factors.

The method can receive a user response to the example at block 108. In one case, the example can be presented to the user on a graphical user interface (GUI). The user can enter his/her response on the GUI. Some implementations may only allow the user to respond with an “answer”. Other implementations may allow other options to the user. For instance, the GUI may offer the user the ability to request a different example. Some of these implementations may allow the user to specify more details about the type of example that he/she wants. For instance, the user may have the option of requesting harder or easier examples. Further still, the user may have the option of requesting examples that relate to a specific aspect of the boundary.

The method can evaluate the active teaching strategy in light of the user's response at block 110. In some implementations, the evaluating can produce two outcomes. First, the present strategy (from block 104) can be retained or a new strategy can be selected. In either case, the strategy (whether new or retained) can be further refined based upon the user response. The method can then return to block 104 and repeat blocks 104-110 in an iterative manner until the task is complete (e.g., until the user has learned the boundary to a sufficient degree of accuracy). Thus, examples can be adaptively selected based on various factors, such as the user's performance.

### System Examples

FIG. 2 shows an example of a system 200 in which active teaching can be employed. System 200 includes a computer 202. The computer 202 can include an active teaching (AT) tool 204 that can operate in cooperation with an operating system 206. The operating system runs on hardware 208 that includes a processor 210, computer readable storage media 212, output devices in the form of a display 214 and speakers (not shown), and input devices in the form of a keyboard 216 and a mouse 218.

The term “computer” or “computing device” as used herein can mean any type of device that has some amount of processing capability and/or storage capability. Processing capability can be provided by one or more processors that can execute data in the form of computer-readable instructions to provide a functionality. Data, such as computer-readable instructions, can be stored on storage. The storage can be internal and/or external to the computing device. The storage can include any one or more of volatile or non-volatile memory, hard drives, flash storage devices, and/or optical storage devices (e.g., CDs, DVDs etc.), among others. As used herein, the term “computer-readable media” can include transitory and non-transitory instructions. In contrast, the term “computer-readable storage media” excludes transitory instances. Computer-readable storage media includes “computer-readable storage devices”. Examples of computer-readable storage devices include volatile storage media, such as RAM, and non-volatile storage media, such as hard drives, optical discs, and flash memory, among others.

Further, while some computers, such as computer 202 utilize a shared resource configuration with a general purpose processor 210, other computers can employ more dedicated resources, such as specific components that are dedicated to achieving a particular functionality. For instance, a given part of the computer's chip may be dedicated to the active teaching (AT) tool. Such computers can be manifest as a system on a chip (SOC) type design. In such a case, functionality provided by the computer can be integrated on a single SOC or multiple coupled SOCs.

Examples of computing devices can include traditional computing devices, such as personal computers, cell phones, smart phones, personal digital assistants, or any of a myriad of ever-evolving or yet to be developed types of computing devices. Further, aspects of system 200 can be manifest on a single computing device or distributed over multiple computing devices.

Continuing with FIG. 2, the AT tool 204 can be configured to teach a user about an operational space 220. Specifically, the AT tool can teach the user about a classification boundary (“boundary”) 222 associated with operational space 220. The AT tool can use a set of examples “x” from the operational space 220 to teach the user the boundary 222. In this case, the set of examples includes examples x₁-x₃₅ as illustrated, but the number of examples is not intended to be critical.

The AT tool 204 can pick an individual example x₁-x₃₅ and present the individual example to the user via display 214 and/or the speakers. The user can respond by labeling the example, correctly or incorrectly, via keyboard 216 and/or mouse 218. Although it is unobserved, the user may internally update his/her mental model based upon exposure to the example. Based on the user's response, the AT tool 204 can update its strategy and can present the next individual example from examples x₁-x₃₅.

In some implementations, the AT tool 204 can consider regions of the boundary 222 individually. For instance, in regards to region 224 the user's performance may indicate that the user does not yet understand how to distinguish the boundary. In such a case, the AT tool 204 may select examples x₄ and/or x₂₁ for presentation to the user since these examples are farther from the boundary and may be easier for the user to distinguish. Conversely, in region 226, the user's performance may indicate that the user is beginning to be able to distinguish the boundary. Accordingly, the AT tool 204 may select examples such as x₇, x₈, x₂₄, and/or x₂₅ that are closer to the boundary (and thus more difficult) rather than examples like x₉ and x₂₇ which are farther from the boundary.

Further still, the AT tool 204 may recognize that even relative to a region of the boundary that the user understands some boundary parameters, but not others. For instance, regions 228 and 230 overlap the boundary 222 proximate to examples x₂₈ and x₂₉. Yet, the user's performance may indicate that his/her understanding of region 228 may be different than the user's understanding of region 230. For instance, assume that region 228 of the boundary relates to color and region 230 relates to texture. The user's performance may indicate that the user can effectively distinguish textures relative to the boundary, but not colors. Accordingly, the AT tool 204 may select examples such as x₁₂, x₂₈, x₂₉, and/or x₃₁ (that are closer to the boundary and thus more challenging) for presentation to the user relative to region 230 (where the user has better performance). The AT tool 204 may select examples x₁₇ and/or x₃₂ (that are relatively distant from the boundary and thus easier) for presentation to the user relative to region 228 (where the user is having more difficulty).

In an alternative configuration, since examples x₂₈, x₂₉, convey multiple parameters, the AT tool 204 may reserve these examples from presentation until the user has established some understanding of both regions 228 and 230. For instance, the AT tool may not present multi-parameter examples x₂₈, x₂₉ until the user has shown proficiency with at least some of the single parameter examples x₁₆, x₁₇, x₃₀, and/or x₃₂ relative to region 228 and single parameter examples x₁₀, x₁₂, x₃₁, and/or x₃₃ relative to region 230. The AT tool could then present multi-parameter examples x₂₈ and/or x₂₉ to solidify the user's understanding of the boundary 222 proximate to regions 228 and 230.

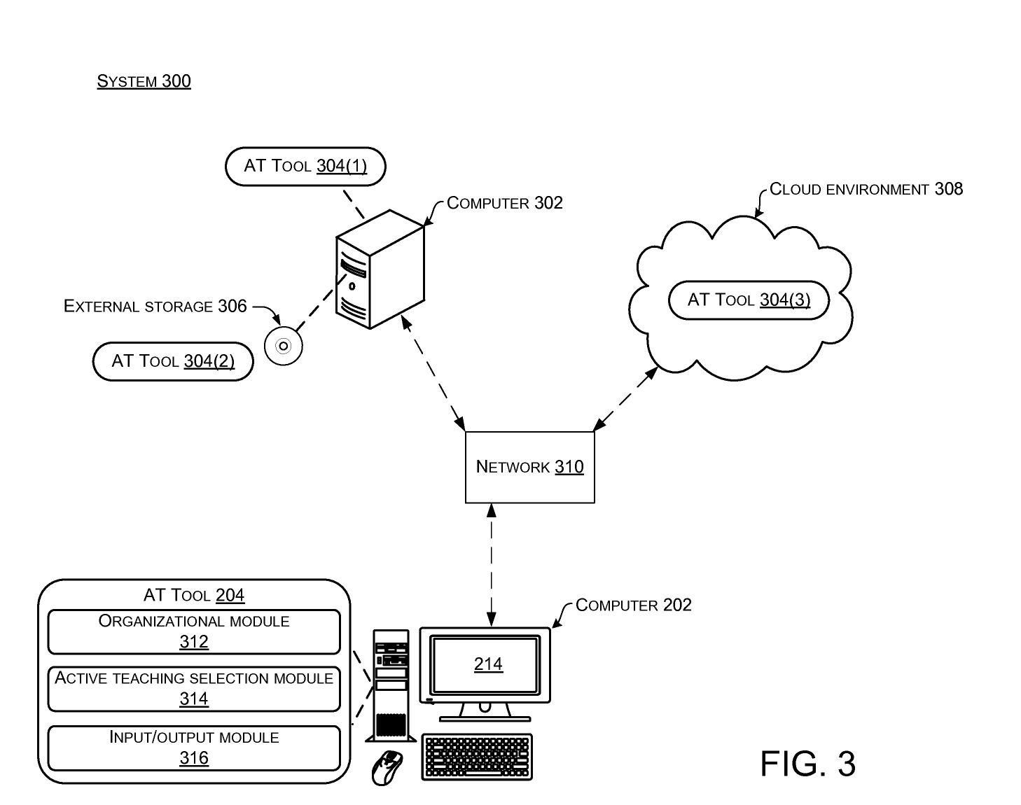

FIG. 3 shows another system 300. FIG. 3 also further describes AT tool 204 associated with computer 202. System 300 also includes another computer 302 and three more AT tools 304(1)-304(3). AT tool 304(1) is associated with computer 302. AT tool 304(2) is associated with (in this case stored on) transferrable storage 306 (e.g. computer readable storage media). In this example, transferrable storage 306 is manifest as an optical disc. Other examples of transferrable storage can include hard drives and flash drives, among others. Transferrable storage 306 can be utilized to associate AT tool 304(1) with a computer, such as computer 202 and/or computer 302. AT tool 304(3) occurs in a cloud environment 308. A cloud environment can include computing resources (such as processing and storage), but the location and allocation of those computing resources may not be as readily apparent as more traditional computing scenarios. Computer 202, computer 302, and cloud environment 308 can communicate over network 310.

In this example, AT tool 204 includes an organizational module 312, an active teaching selection module 314, and an input/output module 316. Though not illustrated for sake of brevity, similar modules can occur on AT tools 304(1)-304(3). Further, an individual AT tool can operate in a stand-alone manner or in a distributed manner. For instance, in one scenario, AT tool 304(1) can include an active teaching selection module and an input/output module while a corresponding organizational module occurs on AT tool 304(3) in cloud environment 308.

Organizational module 312 can be configured to manage examples that relate to a boundary in an operational space. For instance, the organizational module can obtain the examples from an external source and store data relating to the operational space. In some cases, the organizational module may store the examples and their relative distance from the boundary for different parameters. In other cases, the organizational module may generate some or all of the examples from the data relating to the operational space.

The input/output module 316 can operate in cooperation with the input and output devices mentioned above in relation to FIG. 2 and the active teaching selection module 314. The input/output module can be configured to generate graphical user interfaces upon which examples are presented to the user via hardware (FIG. 2). The input output module can then supply any user response to the presented example to the active teaching selection module.

The active teaching selection module 314 can obtain data about the boundary from the organizational module 312. The active teaching selection module can be configured to choose a strategy for teaching the boundary to a user as a classification task. The active teaching selection module can also be configured to select individual examples for presentation to the user based upon the chosen strategy.

In some implementations, the active teaching selection module 314 can possess or access a host of possible strategies. For instance, three non-limiting strategies are listed below. The first strategy can include repeating examples near the most recent wrong example. The second strategy can include presenting examples near the boundary. The third strategy can include finding the points of greatest disagreement if the user has mental model A, B, or C, etc. The active teaching selection module 314 can then pick from the available strategies. Also note, that in some implementations, the active teaching selection module can address the observation that different strategies may work better at different times for the same user. For example, the user might need repetition for a while to build confidence, then some new examples to expand their learning, etc. Accordingly, upon receiving a user response to an example, these implementations can revisit the available strategies in light of the response as well as any other context related to the user, such as previous responses from the user, and/or other factors.

In some implementations, the active teaching selection module 314 can sample a strategy according to the strategy's effectiveness at getting the user to answer correctly or incorrectly given the user's response history. In such a case, the active teaching selection module can drive the results to be “more difficult than random”. For example, instead of showing the user random samples, which would start at chance and get easier as the user learned the concept, the active teaching selection module can keep things difficult by selecting the strategies that will present the difficult points the user has not yet mastered. Thus, the active teaching selection module can determine not only the effectiveness of each strategy, but also which strategy to pursue at a given point in time. Viewed another way, as the teaching proceeds, the active teaching selection module can identify the contribution of the utilized strategies to the user's performance.

The active teaching selection module 314 can alternatively or additionally consider other factors in the strategy selection. For example, the user could get bored or frustrated if the examples presented become too easy or too difficult, respectively. Thus, the active teaching selection module can balance maintaining user interest as well as quickly improving his/her performance. Some implementations can address the user's mental state by allowing the user alternative responses rather than only allowing the user to answer on which side of the boundary the presented example lies. For instance, when the active teaching selection module causes the selected example to be presented to the user, the user is presented with three response options. The user can input that the selected example lies on a first side of the boundary, a second (e.g., opposite) side of the boundary, or the user can request another example. There is also the possibility of a “frustration button” that allows the user to indicate that the current strategy is not desirable to him/her. Other implementations may allow more detailed user input when the user does not want to answer the present example. For instance, the user may be able to specify that the presented example is too hard or too easy. In another case, the user may be allowed to specify what aspects of the boundary are clear or are not clear to the user. For instance, the user may be able to readily distinguish boundary aspects related to “parameter A” and thus request that the presented examples not relate to parameter A. Alternatively, the user may not understand boundary aspects related to “parameter B” and thus request more examples be presented relative to parameter B. This user input can be considered by the active teaching selection module in selecting the next strategy and hence example for presentation.

To summarize, the active teaching selection module 314 can let the human user be more active in the teaching process. Thus, the user can have more control over what the next example will be. For instance, the user can decide if he/she wants a hard vs. an easy example. The user may also be allowed to pick from a gallery of available examples. Alternatively or additionally, the user can be allowed to identify example pairs he/she finds confusing, and then the active teaching selection module 314 can present examples related to the identified pairs.

Another factor that can be considered by the active teaching selection module 314 is the learnability of the boundary generally and/or the learnability of individual regions of the boundary. For instance, in some cases, specific regions of the boundary may relate to a single parameter that can be taught to the user in isolation. In other cases, multiple parameters may be inter-related in a region of the boundary. In the latter case, active teaching selection module 314 can consider the parameters of the region collectively when selecting a strategy to make the region easier for the user to learn.

In some implementations the active teaching selection module 314 may assign a relative hardness (difficulty) of classifying a point, parameter, or region of the boundary. By default, the hardness/difficulty could just be the distance from the boundary. In some cases, the active teaching selection module can show the user the “hardness” of a particular point, such as via color or a graph, among others. This strategy can help the user focus on the more difficult examples versus easier ones. The relative hardness of points can then be considered by the active teaching selection module 314 in selecting examples for presentation so that the selected examples generally move from easy points towards harder points as the user's skill improves.

In still other implementations, the active teaching selection module 314 can estimate/learn what is easy/hard for the human user. The active teaching selection module 314 can then build a predictor of how likely a user is to get a given example right or wrong (i.e., its difficulty for that user). The active teaching selection module can then use these features to help determine which examples to show, e.g., it can order examples from easier to harder as the user's knowledge develops.

Some implementations of the active teaching selection module 314 can combine and/or consider multiple strategies to select examples for presentation. For instance, the hardness and user input mechanisms can be made into strategies that are available to the active teaching selection module. In other implementations, the active teaching selection module can use the hardness (or user input) to filter points, the active teaching selection module can then pick a strategy relative to the remaining points.

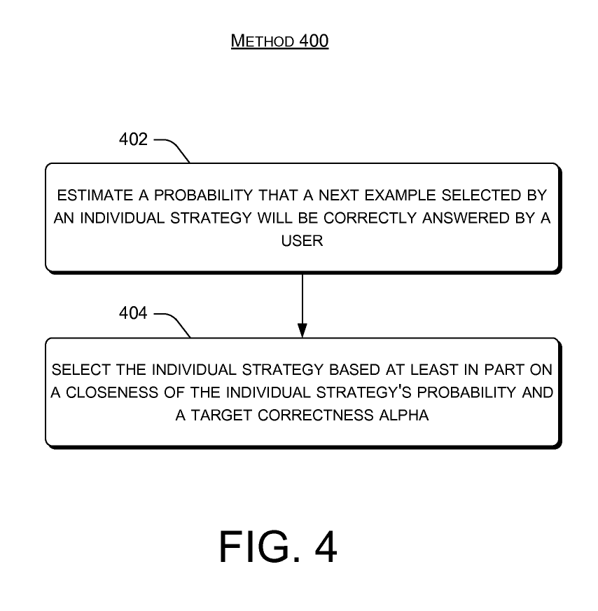

In summary, the active teaching selection module 314 can readily adapt to changing factors, such as the user's performance during the teaching process to select new strategies. A specific strategy selection method that can be employed by the active teaching selection module is described below relative to FIG. 4.

### Strategy Selection Method Examples

FIG. 4 illustrates a flowchart of a strategy selection technique or method 400.

At block 402, the method can estimate a probability or likelihood that a next example selected by an individual strategy will be correctly answered by a user.

In one case, the method can access probability tables for the available strategies. For discussion purposes, examples of two such tables are listed below for two strategies.

The first strategy (strategy I) can be thought of as “choose a nearby point to the previous example”. The effects of this strategy (or any other) on the user can be represented in terms of the probabilities of what will happen next given that this strategy is picked. In particular, these implementations can estimate the probability of whether the user will correctly label the example chosen by the given strategy, dependent on whether they got the last example correct. For this particular strategy (strategy I), the estimated statistics may look as follows:

P(next_answer_correct|strategy=I, last_answer_correct) or P(NAC|S, LAC)=

| | |
|---|---|
| | next |
| Last | answer |
| answer | correct |

| correct | 0 | 1 |
|---|---|---|
| 0 | 0.3 | 0.7 |
| 1 | 0.1 | 0.9 |

The second strategy (strategy II) can be thought of as “pick a point very different from the previous example”. For this strategy, the estimated statistics may look as follows:

P(next_answer_correct|strategy=II, last_answer_correct) or P(NAC|S, LAC)=

| | |
|---|---|
| | next |
| Last | answer |
| answer | correct |

| correct | 0 | 1 |
|---|---|---|
| 0 | 0.5 | 0.5 |
| 1 | 0.5 | 0.5 |

The method can also update individual probability tables to reflect user answers for presented examples in an instance where the probability tables have not already been updated to reflect the answers. For instance, the method can update these tables at each step via simple counts. In one case, the probability tables for this method can also be initialized with a prior distribution that is worth a fixed number of steps. The method can estimate the prior distribution based on pilot data. Thus, if the strategy “choose nearby points” no longer gets good performance, its table can be updated, and the method can pick another strategy.

At block 404, the method can select the individual strategy based at least in part on a closeness of the individual strategy's probability and a target correctness alpha. The target correctness alpha can be thought of as a desired proportion of correct user responses or answers to presented examples.

In some instances, the method looks solely at the closeness of each individual strategy's probability and the target correctness alpha and can select the closest strategy. For instance, given the tables and the target correctness alpha the method can pick the strategy that will move the average score as quickly as possible (i.e., with greatest probability) towards the target alpha. Since the new score is either 1 or 0, a way to express this could be:
If the current alpha is {less than, greater than} the target correctness alpha, the method can attempt to pick i to {maximize minimize} P(NAC|S=i, LAC)

Other implementations can consider other factors and/or “soften” the reliance on the closeness. These implementations can reduce a likelihood of relatively small errors in the estimates causing one strategy to be selected and another maybe equally valid strategy to be ignored. For instance, if a first strategy is assigned a probability value of 0.9 and a second strategy is assigned a probability value of 0.89 some implementations may select the first strategy and totally ignore the second strategy. However, it is possible that potential errors in the probability calculation process are greater than the difference separating the two probabilities. It may be that both the first and second strategies can contribute meaningfully to the example selection process. Some implementations can address such scenarios by “softening” the reliance on the closeness between the estimated probabilities of the strategies and the target correctness alpha in strategy selection. So, for instance, in the above scenario, some implementations may try to consider both the first and second strategies in selecting an example for presentation rather than simply relying on the first and discarding the second.

A potential “softening” variation could be to sample from the strategies according to their value:
If the current alpha is {less than, greater than} the target alpha,
   the method can pick a strategy by sampling according to the probability distribution {P(NAC=1|LAC, S=i)/Z, P(NAC=0|LAC, S=i)/Z}, where Z is a normalizing constant such that the distribution sums to 1.

Another potential method of picking a strategy can be to try to reduce or minimize the difference between the expected average score and the target score. In the equations below, avscore[t] is the average of score[t] over a window of N samples, and E[ ] denotes expectation. The expected average score after the next example (n+1) can be expressed as:

E[avscore[n+1]|S=i]=(score[n−N+2]+ . . . +score[n]+E[score[n+1]|S=i])/N
where the expected value of the score can be written at the next example as:

E[score[n+1]|S=i]=P(NAC|LAC,S=i)
One goal is then to reduce and potentially minimize the difference between the expected average score and the target alpha

Min(over i)|E[avscore[n+1]|S=i]−alpha|

Another strategy selection technique can be expressed as:
EAS=Expected Average Score as above. This technique can attempt to reduce or minimize L=|EAS−alpha|, so compute L_i for each strategy i:
Now set p_i=(1−L_i)/Z (where Z is a normalizing constant to make the distribution sum to 1) and sample from the strategies according to this distribution.

As many strategies may have similar probabilities p_i according to this metric, their difference can be emphasized by first subtracting off the minimum L_i and dividing by the maximum L_i (i.e, normalizing the L_i between 0 and 1).

Some implementations may consider still other factors in strategy selection. For instance, some strategies may consider long term benefit to the user rather than, or in addition to, short term benefit. For example, a particular strategy may select examples that aid the user in answering future examples yet do not offer the optimum probability for correctly answering the next example. For instance, the particular strategy may select examples that teach the user in a manner that culminates in a high level of user understanding after say another ten examples. However, this particular strategy may not be the closest match to the target correctness alpha for the next example when compared to some other strategies.

One class of strategies that could fall in this category includes strategies that re-select examples for purposes of review. There can be strategies that do a review of past examples or example areas. Various weighting techniques could be utilized so that this class of strategies is not effectively excluded from selection. Recall that some implementations can consider the possibility of user discouragement in the strategy selection process. In instances where the user has incorrectly answered several questions, the chance of discouragement grows. In these instances, the rank of strategies which select review questions should go up since users are more likely to correctly answer review questions. Accordingly, when considering multiple factors and/or statistical data, the method can be more likely to select a member from this class of strategies than might otherwise be the case. Another possibility is to set a fixed probability of selecting review examples, ensuring that review problems would be selected with some frequency.

The order in which the example methods are described is not intended to be construed as a limitation, and any number of the described blocks or steps can be combined in any order to implement the methods, or alternate methods. Furthermore, the methods can be implemented in any suitable hardware, software, firmware, or combination thereof, such that a computing device can implement the method. In one case, the method is stored on one or more computer-readable storage media as a set of instructions such that execution by a computing device causes the computing device to perform the method.

In summary, the above method can choose a strategy with which to select the next example. In some cases, a single factor can be utilized to calculate relative merits of the available strategies. Other implementations can balance multiple factors when calculating the relative merits of the available strategies.

### CONCLUSION

Although techniques, methods, devices, systems, etc., pertaining to active teaching are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. At least one computer-readable storage medium having instructions stored thereon that, when executed by a computing device, cause the computing device to perform acts, comprising:
obtaining examples and a boundary associated with an operational space;
choosing an active teaching strategy to teach the boundary to a user as a classification task;
selecting an individual example for presentation to the user utilizing the active teaching strategy;
receiving a user response to the individual example;
evaluating the active teaching strategy in light of the user response, and,
updating the chosen active teaching strategy in light of the evaluation.

2. The computer-readable storage medium of claim 1, wherein the choosing comprises choosing the active teaching strategy to teach the boundary to the user to explain a behavior of a classifier via active teaching, to train the user as a labeler that is consistent with other human labelers, or to teach the user a real-world task.

3. The computer-readable storage medium of claim 1, wherein the receiving further comprises updating statistical data associated with a performance of the user.

4. The computer-readable storage medium of claim 1, wherein the evaluating comprises analyzing the user response and the user's performance at learning the boundary.

5. The computer-readable storage medium of claim 1, wherein the updating comprises selecting a different active teaching strategy.

6. The computer-readable storage medium of claim 1, wherein the evaluating comprises evaluating the active teaching strategy utilizing a conditional probability table.

7. A computer-implemented method, comprising:
accessing a set of examples, wherein the examples occur on both sides of a boundary of a classification task;
selecting an individual example from the set to present to a user based upon an active teaching strategy for teaching the user the boundary;
evaluating a response of the user to the example;
updating the active teaching strategy based upon the evaluating; and,
selecting another individual example from the set to present to the user based upon the updated active teaching strategy, wherein the selecting another individual example comprises balancing an efficiency parameter and a discouragement parameter.

8. The computer-implemented method of claim 7, wherein the response of the user is one of an answer or a request for a different individual example.

9. The computer-implemented method of claim 7, wherein the efficiency parameter drives selection of relatively more difficult examples to teach the boundary with as relatively few of the examples from the set as possible and wherein the discouragement parameter drives selection of examples from the set that maintain the user's confidence.

10. The computer-implemented method of claim 7, implemented on one or more computer-readable storage media.

11. A system, comprising:
an organizational module configured to manage examples that relate to a boundary in an operational space; and,
an active teaching selection module configured to choose a strategy for teaching the boundary to a user as a classification task and to select individual examples for presentation to the user based upon the selected strategy.

12. The system of claim 11, wherein the organizational module is configured to obtain the examples from an external source or to generate the examples.

13. The system of claim 11, further comprising an input/output module configured to present the selected individual examples to the user and to communicate a user response to the organizational module.

14. The system of claim 13, wherein the active teaching selection module is further configured to update subsequent choosing and selecting based upon the user response.

15. The system of claim 13, wherein the active teaching selection module is further configured to divide the boundary into regions and to select individual strategies for individual regions.

16. The system of claim 13, wherein the active teaching selection module is further configured to recognize individual parameters taught by the boundary and to select individual strategies for teaching the individual parameters.

17. The system of claim 13, wherein the active teaching selection module is further configured to estimate the user's perceived difficulty of an individual example, and to use this estimate to deliver further examples of appropriate and increasing difficulty to the user based on the user's current abilities.

18. The system of claim 13, wherein the active teaching selection module is further configured to maintain probability tables for individual strategies that indicate an estimated likelihood that a next example selected by the individual strategies will be correctly answered by the user.

19. The system of claim 18, wherein the active teaching selection module is further configured to select the individual strategy that is most likely to bring the user's average score closer to a target correctness alpha.

20. The system of claim 13, wherein the system is embodied on a single computer.
